(19) United States
(12) Patent Application Publication
(10) Pub. No.: US 2012/0310727 A1
(43) Pub. Date: Dec. 6, 2012

(54) METHOD AND SYSTEM FOR GENERATION OF ANONYMOUS PROFILES FROM A TRI-LEVEL MAPPING OF MOBILE NETWORK MARKETING ECONOMETRICS

(75) Inventors: Nathaniel T. Bradley, Tucson, AZ (US); Mark Baker, Marietta, GA (US); Sean Bradley, Tucson, AZ (US); Joshua S. Paugh, Tucson, AZ (US); Anthony Iacovone, Huntington, NY (US); Douglas F. Bender, Scotts Valley, CA (US); Jim G. Crawford, Fall City, WA (US)

(73) Assignee: Augme Technologies, Inc., New York, NY (US)

(21) Appl. No.: 13/486,101

(22) Filed: Jun. 1, 2012

Related U.S. Application Data
(60) Provisional application No. 61/493,223, filed on Jun. 3, 2011.
(60) Provisional application No. 61/640,379, filed on Apr. 30, 2012.

(51) Int. Cl. G06Q 30/02

(52) U.S. Cl. 705/14.41; 705/14.58; 705/14.53

(57) ABSTRACT

A method and system for measuring interest in a product. A processor operating on a server receives an identifier associated with a mobile computing device. The processor determines a location of the mobile computing device within a marketing environment and associates the location of the mobile computing device with a location of a product. The processor obtains interaction data indicative of an engagement of the mobile computing device with the product and determines a measure of interest in the product using the interaction data. Alternatively, data indicating an interaction of the mobile computing device with a product are received by the processor. The product location, which is known, is used to determine the location of the mobile computing device.

### CROSS REFERENCE TO RELATED APPLICATIONS

This application claims priority under 35 U.S.C. §119(e) from provisional application No. 61/493,223 filed Jun. 3, 2011 and from provisional application No. 61/640,379 filed Apr. 30, 2012. The 61/493,223 and the 61/640,379 provisional applications are incorporated by reference herein, in their entireties, for all purposes.

### BACKGROUND

Cellular telephones have evolved from simple voice and text communication devices to mobile computing platforms complete with processors, Internet browsers, operating systems and even software plug-ins such as JAVA. Today, Internet enabled “smartphones” have become a leading driver of growth in Internet traffic and utilization by consumers. Due to that growth, publishers are refocusing to reach consumers through mobile websites and initiatives.

The accessibility of consumers while roaming also presents opportunities for capturing data from and about users of smartphones. These data are potentially valuable assets that may be used to generate consumer profiles that may be used by marketing companies to generate targeted advertisements. For example, using location data generated by a smartphone, a consumer's location relative to the location of retailers may be tracked. These data may be used to provide the consumer information about the retailer and its products and services and to offer consumers discounts to try a product and/or to remain loyal to a product. Additionally, these data may be used to provide the retailer information about the consumer and his or her likes and dislikes.

From the perspective of a consumer, systems that, without the permission of the consumer, track his or her location and utilize these data for marketing and other purposes raise significant privacy issues regardless of any benefits the consumer may received in return. From the perspective of a seller of products and services, the promise of mobile tracking systems may be costly to realize because control over the geographic information exposed in mobile network usage remains with the wireless network operators or the suppliers of the mobile devices and may be less than advertised because of consumer privacy concerns.

### SUMMARY

Embodiments are directed to mapping mobile marketing engagements of consumers who voluntarily agree to participate (i.e., “opt-in”) in product marketing campaigns to geospatial locations without the use of information generated by mobile network usage.

In an embodiment, an anonymous statistical model relates opted-in consumer engagements to three data layers that make up a tri-level mapping system. In this embodiment, the engagements are tracked, not the consumers. An anonymous consumer record is produced that transforms data used to associate user profiles with products, brands and retail real estate into actionable, and valuable mobile marketing analytics.

In an embodiment, retail environments are mapped. Using this mapping, intelligence and econometrics can be derived without any geographic information being taken from the mobile device. Mobile engagements are anonymously tracked as they overlap with retail real estate and as they relate to products, promotions and brands. The opt-in nature of any consumer engagement allows the consumer to engage and enjoy rich mobile marketing experiences on an anonymous basis without the data intrusion, identity exposure, and geo-location traction that occurs with existing GPS based consumer tracking systems.

In an embodiment, interest in a product is measured. A processor operating on a server receives an identifier associated with a mobile computing device. This may be via the user allowing the user's mobile device to be scanned or via an app on the user device notifying an in-store scanner/server of the presence of the user mobile device. The processor determines a location of the mobile computing device within a marketing environment and associates the location of the mobile computing device with a location of a product. The processor obtains interaction data indicative of an engagement of the mobile computing device with the product and determines a measure of interest in the product using the interaction data. In an alternate embodiment, data indicating an interaction of the mobile computing device with a product are received by the processor. The product location within an environment, which is known, is used to determine the location of the mobile computing device when it is within range of that particular product.

### DESCRIPTION OF THE DRAWINGS

FIG. 1 is a block diagram illustrating a network for collecting and processing consumer engagement data according to an embodiment.

FIG. 2 is a block diagram illustrating data structures of a tri-level mapping system according to an embodiment.

FIG. 3 is a block diagram illustrating a facility and floor plan datastore of a tri-level mapping system according to an embodiment.

FIG. 4 is a block diagram illustrating a product placement location datastore of a tri-level mapping system according to an embodiment.

FIG. 5 is a block diagram illustrating a consumer engagement datastore according to an embodiment.

FIG. 6 is block diagram illustrating a correlation model according to an embodiment.

FIG. 7 is a block diagram illustrating a process for measuring an interest of a user of a mobile device in a product according to an embodiment.

FIG. 8 is a block diagram of a computing device.

### DETAILED DESCRIPTION

As used herein, the term “anonymous” encompasses the treatment of data that comes from opted-in consumers wherein consumer personal information is not used, stripped from data records or otherwise is sanitized so that individual consumer identity is not discoverable.

As used herein, the term “engage” encompasses any activity of a consumer whereby a consumer takes an affirmative interaction with a particular product or service that results in a data record of that interaction. An engagement may occur inside a retail facility, outside of a retail facility or in a virtual environment.

As used herein, the term “planogram” encompasses the physical location of products, promotions, and brands within a floor plan of a retail facility.

As used herein, the term “product” at least encompasses tangible and intangible goods, rights, services, brands public personalities, programs, group affiliations, belief sets and the like.

As used herein, the term “mobile computing device” at least encompasses a mobile device that is configured to interact with objects and images. By way of illustration and not by way of limitation, a smartphone, a tablet, and a personal data assistant are examples of mobile computing devices.

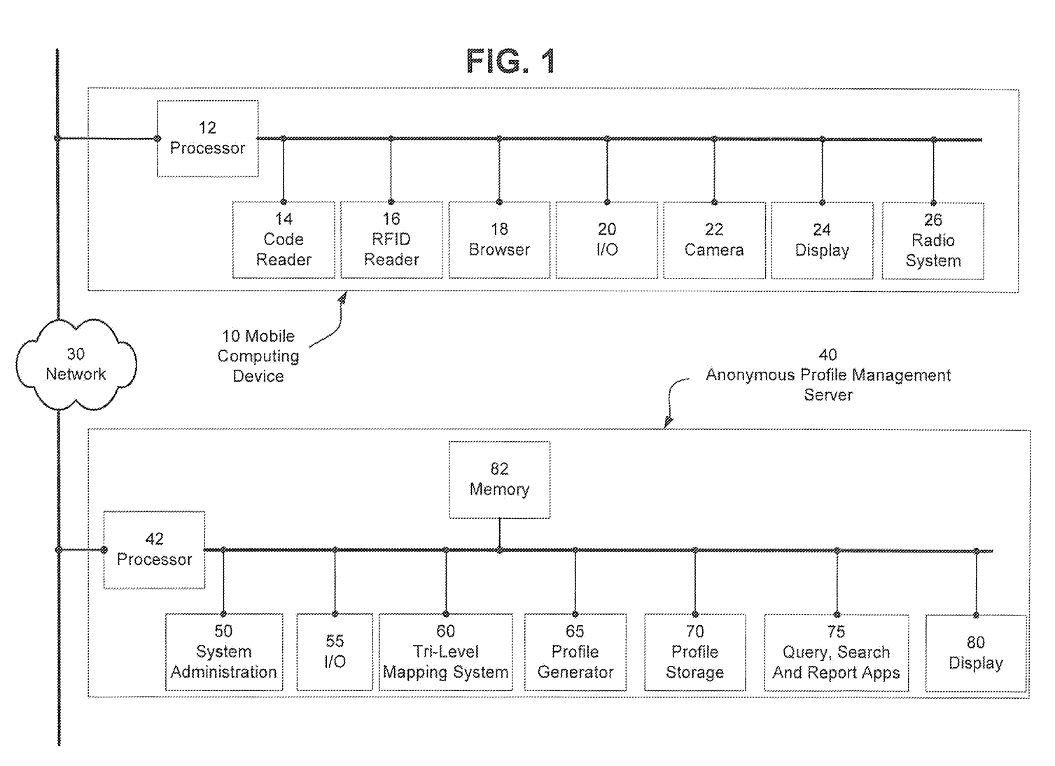

FIG. 1 is a block diagram illustrating a network for collecting and processing consumer engagement data according to an embodiment. A mobile computing device 10, such as smartphone, a tablet, and a personal data assistant, and an anonymous profile management server 40 are connected to each other via a network 30. In an embodiment, the network 30 is the Internet.

The mobile computing device 10 comprises a processor 12, a code reader 14, an RFID reader 16, a browser 18, an I/O system 20, a camera 22, a display 24 and a radio system 26. The mobile computing device 10 may include some or all of features 14, 16 and 22. The mobile computing device 10 may include additional features that are not illustrated for purposes of clarity.

The anonymous profile management server 40 is also connected to the network 30 and comprises a processor 42, system administration tools 50, an I/O system 55, a tri-level mapping system 60, a profile generator 65, profile storage 70, query, search and reports applications 75 and a display 80. A memory 82 may store software instructions which may be executed by the processor 42 to cause the anonymous profile management server 40 perform operations described below. The profile management server 40 may include additional features that are not illustrated for purposes of clarity.

In an embodiment, a user of the mobile computing device 10 (the user not being illustrated in FIG. 1), voluntarily agrees to participate in (“opts-in”) a marketing initiative and to provide information relating to the engagement of the user with one or more products or services involved in the initiative or with a facility at which such products or services may be acquired. As will be discussed in detail below, the raw engagement data may be acquired by the mobile computing device 10 via a code read by the code reader 14, by a code received from an RFID tag read by the RFID tag reader 16, by a link entered by the user in the browser 18, by a picture taken by the user using the camera 22, by a text message created by the user using the I/O system 20 among others and processed by the processor 12 into readable data.

The engagement data are received by the anonymous profile management server 40 and processed. In an embodiment, the raw engagement data are processed by the processor 42 against the tri-level mapping system (discussed in the detail below), to relate the engagement data to geo-spatial data without the need for any geographic information generated by the mobile computing device 10. The processed engagement data may be used by the profile generator 65 to create and update a profile for the user of the mobile computing device 10 that is stored in the profile storage 70. The query, search and reports applications 75 may be used to search datastores and to analyze profiles and engagement data.

While FIG. 1 illustrates a single server 40 and a single processor 42, multiple servers and processors may be used to receive and process engagement data and to produce and display data, reports and searches performed by query, search and report applications 75 against profiles stored in profile storage 70.

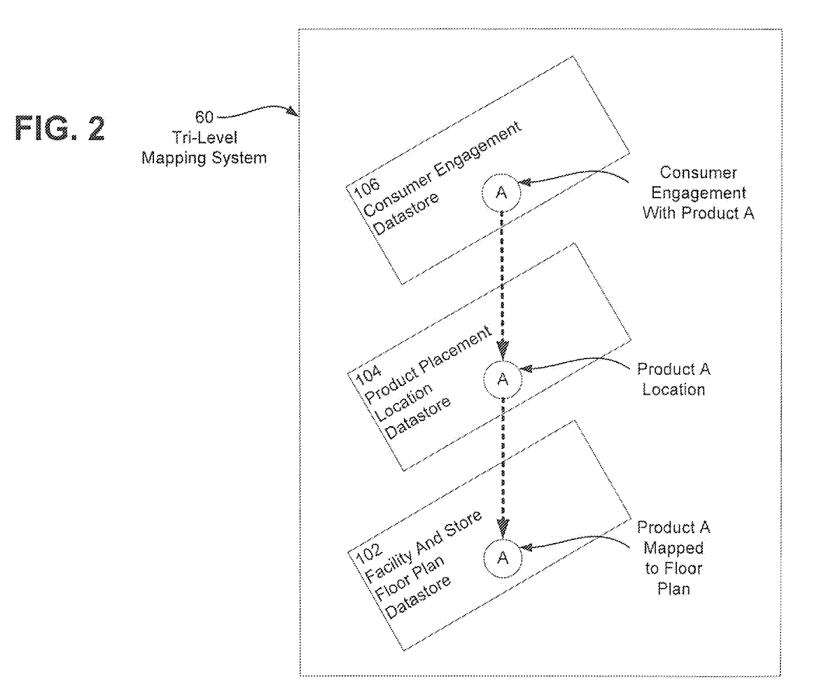

FIG. 2 is a block diagram illustrating data structures of a tri-level mapping system according to an embodiment.

As illustrated in FIG. 2, a tri-level mapping system 60 comprises a facility and store floor plan datastore 102, a product placement location datastore 104 and a consumer engagement datastore 106. The tri-level mapping system 60 utilizes data from the facility and store floor plan datastore 102 to map a floor plan of a retail establishment having a known physical address. The tri-level mapping system 60 relates product placement location data from the product placement location datastore 104 to the retail floor plan data from the facility and store floor plan datastore 102. For example, the floor plan data of a “big box store” may define a space within the floor plan using a coordinate-based mapping system. A product A may be assigned to a particular location with that defined space by the product placement location data stored in the product placement location datastore 104. When a consumer chooses to engage product A (the engagement process is described in detail below), consumer engagement data is produced indicative of the consumer's interaction with product A and stored in the consumer engagement datastore 106. These data may be used to create, enhance or modify a profile of the subscriber and may be used to locate the subscriber at the time of the engagement with product A in the big box store at the location where product A has been assigned.

As will be described in detail below, the consumer's engagements with other products in other retail establishments, outside of a retail establishment or in virtual environment may be used to produce a detailed profile of the consumer that may be used for marketing purposes. It is important to emphasize that the engagement data is only collected when the consumer elects to engage with products and product offerings. A consumer's location is not tracked using GPS or other location systems but by mapping engagement data to product placement location data and floor plan data. As will be further described, the device by which the consumer engages a product may be known by an identifier (e.g., a phone number), but the identifier is not used to obtain personal data of the subscriber. Thus, the systems and methods described here are both voluntary and anonymous.

Facility and Floor Plan Datastore (Layer 1)

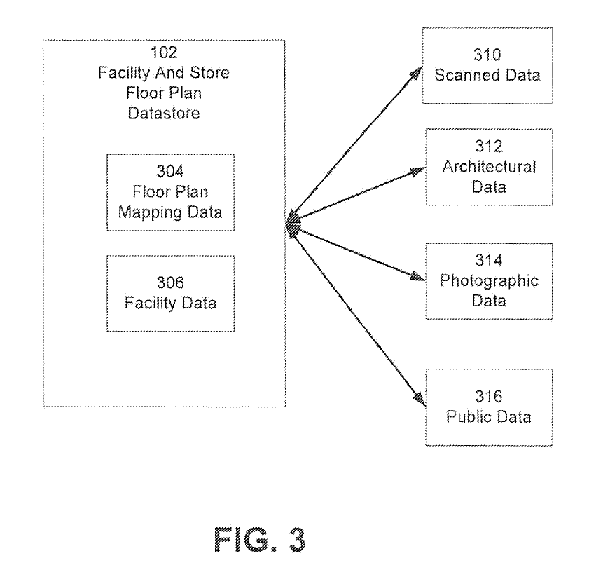

FIG. 3 is a block diagram illustrating a facility and floor plan datastore of a tri-level mapping system according to an embodiment.

As illustrated in FIG. 3, a facility and floor plan datastore 102 occupies a first layer of the tri-level mapping system 60. The facility and floor plan datastore 102 comprises facility and floor plan map data and additional data about a particular facility that are obtained from multiple sources.

Referring to FIG. 3, the facility and store floor plan datastore 102 is populated using data obtained from multiple sources. For example, scanned data 310 may be obtained by scanning images illustrating a floor plan of a retail store or facility. For example, such data may be obtained from a brochure provided by a mall or a retail establishment and stored as floor plan mapping data 304.

Architectural data 312 may also be obtained from a retail facility, from a third party or from other sources.

Photographic data 314 may also be obtained from photographs provided by retailers, consumers or third parties. For example, a data record may be created by simply taking a picture of a mall layout on a map directly from a sign at mall.

Public data 316 may also be obtained from public sources, such as websites and governmental agencies.

While four sources of data have been illustrated, the sources of the data stored in the facility and store floor plan datastore 102 are not limited. Additionally, these data may be updated through real time user input, editing, and overwriting or through automated means.

In an embodiment, the data stored in the facility and store floor plan datastore 102 includes information 106 about a retail facility. By way of illustration and not by way of limitation, facility information 106 may include the location, physical address, and physical attributes of the retail facility, information about the area in which the facility is located, the facility brand, the facility's target market, socio-economic data related to the facility and its location, retail infrastructure information, and personnel profiles of the facility's employees. The information characterizing the retail facility at a location may be dynamically updated as rebranding, relocations, renovations, and retail equipment or facility upgrades are made.

The data held in the facility and store floor plan datastore 102 may be compiled both in a three dimensional visual and text based medium and displayed in a virtual environment via display (see, FIG. 1, block 80).

In an embodiment, the facility and store floor plan datastore Block 102 is configured to enable the upload, from a plurality of sources and network enabled devices, floor plans from scanned images, digital files, mall layouts, architectural drawings and retail schematics that document physical retail locations and store them as floor plan mapping data 104. In another embodiment, the facility and store floor plan datastore 102 provides for the duplication of floor plans such as those used in franchise operations and multi-unit operations that have similar or identical architecture from location to location.

In another embodiment, query, search and reporting applications (see, FIG. 1, block 75) allow for system wide data at this layer to be accessed, modified, batched, secured, reported, syndicated and delivered through automatic data feeds to third parties. In another embodiment, the facility and store floor plan datastore 102 may be hosted in an isolated network or a community of interconnected networks. It can also be hosted on third party systems such as those operated by Content Delivery Networks (CDN's), telecommunications networks, and mobile communication providers.

In another embodiment; access to the facility and store floor plan datastore 102 is tiered. Security protocols may be implemented to provide users with varying levels of access and control over the data through the functions of the administrative system of the anonymous profile management server 40 illustrated in FIG. 1. The export, import and creation of administrator, customer, user and third party branded accounts are enabled through this administrative system.

Product Placement Location Datastore (Layer 2)

As illustrated in FIG. 2, a product placement location datastore 104 occupies a second layer of the tri-level mapping system 60. The product placement location datastore 104 comprises the location of products relative to the facility and store floor plan data held in facility and store floor plan datastore (FIG. 2, Block 102).

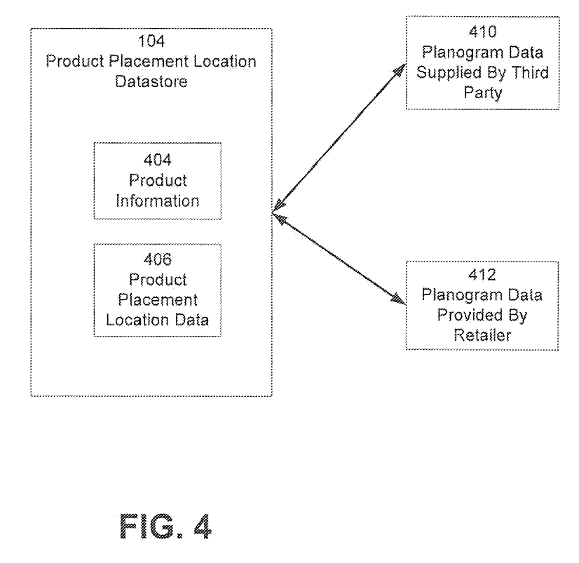

Referring to FIG. 4, the product placement location datastore 104 comprises product information 404 and product placement location data 406. The product information 404 and product placement location data 406 may be derived from planogram data 410 supplied by a third party or from planogram data 412 supplied by a retailer. The product placement location data 406 relates the product information to a physical location of the product within a retail facility as floor plan mapping data that is stored in the facility and store floor plan datastore (FIG. 2, Block 102).

Planograms are used in a variety of retail areas. A planogram defines which product is placed in which area of a shelving unit and with which quantity it is displayed. The rules and theories for the creation of a planogram are well studied and known by those skilled in the art. For example, a planogram may be used by retailers that want multiple, stores and displays within them to have the same look and feel to consumers. Often a manufacturer of consumer packaged goods will release a new suggested planogram with a new product to show how the new product relates to existing products in any given category.

In an embodiment, using the query, search and reports applications (Block 75, FIG. 1) of the anonymous profile management server (Block 40, FIG. 1), an authorized user may zoom in and out of the data held in the product placement location datastore 104 through a networked, secure software as a service (SaaS) interface that selects data of retail outlet locations. The user may also navigate from an administrative panel to view retail planograms containing specifics about the product and brand locations within retail environments.

In another embodiment, the product placement location datastore 104 contains multiple planograms that are networked and responsive to user and automatic data input. These planograms may be constantly updated to reflect a near real-time inventory and brand configuration that is present and mapped by this layer onto the retail and facility floor plan mapping data held in the facility and store floor plan datastore (FIG. 2, Block 102).

In an embodiment, the data held in the product placement location datastore 104 may be responsive to automated inventory monitoring systems such as RFID systems, optical shelving sweep system, and other automated data entry systems. Photographic and retail image mapping technology may also be used in connection with the product placement location datastore 104 to dynamically produce snap shot inventory and video interval analysis to populate planograms.

In another embodiment, text and box based planograms such as those used by high volume consumer goods organizations and supermarkets may be processed into product placement location data 104 and used to map the brands and products within such retail environments.

In another embodiment, pictorial planograms that illustrate “the look” and also identify each product may be imported into the product placement location datastore 104.

Referring again to FIG. 2, the first two layers of the tri-level mapping system 60 comprises a facility and store floor plan datastore 102 and a product placement location datastore 104. Together, these datastores provide at least the following functionality:

Creating product planograms that can automatically replicate across a franchise and multi-unit operation.

Providing a model of the physical locations of brand presence in the retail environment. Tracking and mapping of products can be achieved through automated means and product SKU's, barcodes, marks, RFID and other product identification methods.

Providing administrators a data content node that contains products and brands and can be searched, all or in part, based on the security and access credentials of the user.

In an embodiment, facility and store floor plan datastore 102 utilizes a database architecture on scalable networked computer resources in a server array or in a closed system self contained network that is configured to leverage, query, and store in permanent or temporary memory or storage product and brand data from third party resources including but not limited to:
Product Price
Product Description
Brand Affiliation
Brand
Brand Planogram
Product Logo
Brand Logo
Product Protection (Trademark, Patent)
Product Images
Product Videos
Product Audio Tracks
Demonstrations
Website URLs-Brand-Product
Brand Related Public Filings
Related Stock Data/Display
Barcodes
Product SKUs
QR Codes
2D Codes
Product Documentation
RFID Data and Transmission
Competing Brands
Competing Products

Consumer Engagement Datastore (Layer 3)

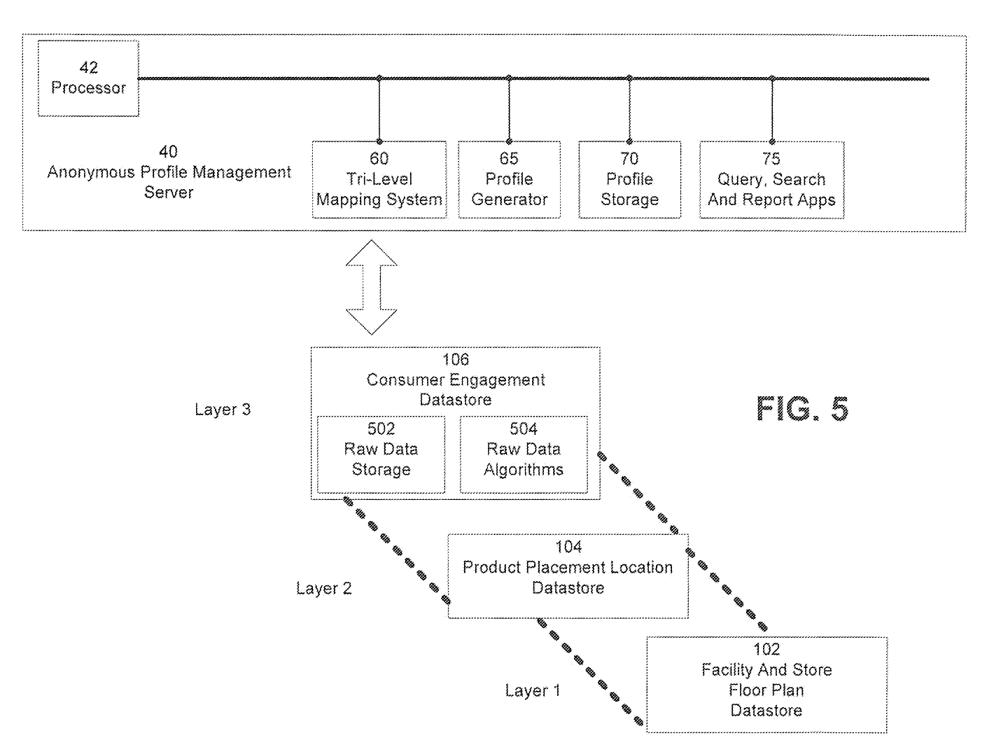

FIG. 5 is a block diagram illustrating a consumer engagement datastore according to an embodiment.

As illustrated in FIG. 5, the consumer engagement datastore 106 is a third layer of a tri-level mapping system 60. The tri-level mapping system 60 is a component of an anonymous profile management server 40. The consumer engagement datastore 106 comprises raw data storage 502 and raw data algorithms 504.

A consumer may “engage” a product, service or retail environment in a number of ways. By way of illustrations and not by way of limitation, engagement data may be acquired from consumer interactions with:
Virtual Reality
Augmented. Reality
Scans
BarcodeS
QR Codes
Image Recognition
Bio Metric Activations
Audio. Recognition

As previously noted, an “engagement” may occur in a store, outdoors, in a virtual reality environment or directly with a product (referred to herein as a “secondary engagement”). For example, a consumer may engage a product outside a retail facility by photographing an object-associated with that product. The object may be a store front, a brand mark, or an advertisement displayed on a bus, a billboard or a bench. A consumer may engage a product at home by photographing the product or be engaging an active or passive code on the product. A consumer may also engage a-product on-line or virtually via images sent to a video terminal device such as a set top box or a media terminal connected to a video display device. In these embodiments raw consumer engagement data are received at, the consumer engagement datastore 106 from mobile computing device 10 (see, FIG. 1), stored in raw data-storage 502 and processed by processor 42 using the raw data algorithms 504 against data held in a secondary engagement datastore (not illustrated). In another embodiment, the processed consumer engagement data are further processed by the profile generator 65 and stored in the profile storage 70. In still another embodiment, the secondary engagements are associated with retail facilities known to be frequented by the consumer or other landmarks to acquire a probable location of the consumer when the secondary engagement occurred.

The raw data algorithms may include a tri-layer path equation which can be used to produce mobile marketing analytics and data that associate user profiles with products, brands and mobile marketing engagements.

As previously described, raw consumer engagement data are received at the consumer engagement datastore 106 from mobile computing device 10 (see, FIG. 1), stored in raw data storage 502 and processed by processor 42 using the raw data algorithms 504 against data held in the facility and store floor plan datastore 102 and the product placement location datastore 104. In another embodiment, the processed consumer engagement data are further processed by the profile generator 65 and stored in the profile storage 70.

While FIG. 1 and FIG. 5 illustrate a single server 40 and a single processor 42, multiple servers and processors may be used to receive and process engagement data and to produce and display data, reports and searches performed by query, search and report applications 75 against profiles stored in profile storage 70.

In an embodiment, search and report applications 75 operates a decision engine that tracks, calculates and records the engagement of mobile marketing campaigns, offers, promotions, discounts, and other mobile marketing metrics.

In another embodiment, the data held in the consumer engagement datastore 106 can be queried and managed by administrators and users that view data, all or in part through a secure software as a service (SaaS) platform based on credentials and data access levels.

Profile Management

Brand Identity

In an embodiment, an anonymous consumer record may be associated with brands and products engaged by a mobile computing device associated with that record using the data contained within layers one and two of the tri-level mapping system 60.

Brand Mapping

In an embodiment, the geographic footprint of products, brands, and mobile engagements may be placed within layers one and two of the tri-level mapping system 60. This results in the ability to create and render visual display of a brand, product or mobile marketing deployment. Further, as users engage with the system, and are anchored into geographic locations as present in layers one and two, the footsteps of the consumer may be rendered in a visual display.

Brand Strength

In an embodiment, the strength of a brand within the profile of a consumer or within the profiles of a group of consumer profiles may be represented graphically and/or numerically. The brand strength may be based on the number of engagements the profile has had with a brand and the quality of those engagements in terms of conversion, opt-in or any other measure of mobile marketing campaign engagement.

Brand Profile

In an embodiment, the combination of brands in a consumer profile comprise a brand profile. Brand profiles may be quickly queried by system administrators. For example, a query may request brand profiles that are similar as defined by the query or that are exactly alike. Reports may be automated, customized and refined using the search and report applications 75 components of the anonymous profile management server 40.

Brand Profile Matching, Grouping, Categorizing

In an embodiment, the search and report applications 75 components may be used to create reports and data displaying the relationships, groupings and categorizations of brand profiles in a mobile marketing context. The anonymous nature of data and associated user profiles over the three layers of the tri-level mapping system 60 allows for users to engage and opt-in to mobile Marketing engagements securely. In an embodiment, reports created using brand-profiles can aid customers of the software as a service platform to switch users from brand to brand or to market to opted-in mobile users that share common brand profiles.

Measuring Interest in a Product and Marketing Effectiveness

As used herein, the term “product” at least encompasses tangible and intangible goods, rights, services, brands public personalities, programs, group affiliations, belief sets and the like.

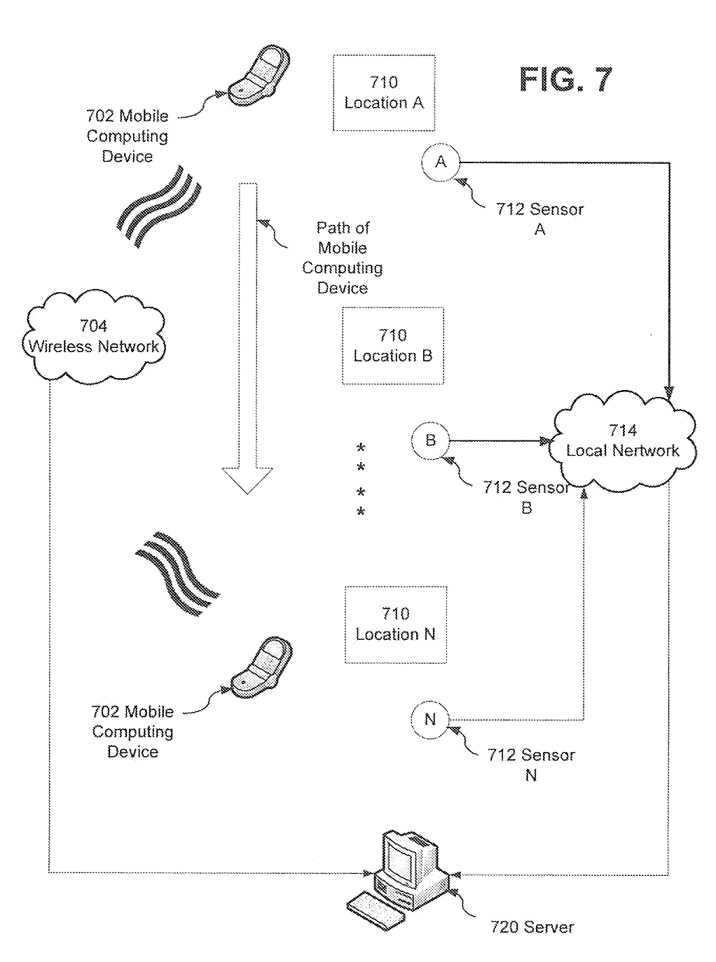

FIG. 7 is a block diagram illustrating a process for measuring the interest of a participant in a product and measuring the effectiveness of a marking campaign according to an embodiment. A mobile device (Block 702) moves along a path through a marketing environment. The path of the mobile device places it in proximity to monitored locations A, B through N. (Blocks 710) The locations A, B through N (Block 710) may be monitored by sensors A, B through N. (Block 712.) The sensors report interest data to a server (Block 720) via a local network (Block 714). Additionally, the mobile device reports interaction data indicative of interactions that occur at locations A, B through N (Blocks 710) via a wireless network (Block 704) to the server (Block 720). Such activity may be, without limitation, the scanning of a code associated with a product in the shopping environment The monitored data and the interaction data may be analyzed by the server (block 720) to determine when a user is in proximity to an object (such as a product) at a location, how long the user remained in proximity to the object and whether and to what degree the user of the mobile device interacted with the object. Shopping patterns involving the mobile device of the user (Block 702) may also be determined.

The monitoring data may be acquired by the sensors A, B through N (Blocks 712) installed in the shopping environment that detect the presence of the mobile device (Block 702). Alternatively or in addition to the sensor data acquired from sensors. A, B through N (Blocks 712), the interaction data acquired by the mobile device (Block 702) may be used to determine the location of the mobile device (Block 702) by correlating the interaction data with location information of the objects with which the mobile device interacts. For example, the mobile device (Block 702) may scan tags or capture images of objects in the shopping environment that have known locations that are stored on the server (Block 720). The physical location of the tags or objects can be used to identify the location of the mobile computing device. The location data may be used to relate the location of the tags or objects to the location of particular products. The time that the user comes in proximity to a tag or object and the time when the user moves away from the tag or object may be, recorded.

The time and proximity data may be analyzed to determine a measure of interest of the user in a particular product. For example, the data may be used to determine the speed at which mobile computing device passed a product, the time the mobile computing device hovered near a product, whether the mobile computing device returned to the location of a particular product, and whether the user of the mobile computing device showed interest in products related to the particular product. The data may also be used to determine whether the user entered the shopping environment to make a pre-planned purchase, was merely browsing, or was influenced by a particular display or offer.

The data for all participants in the marketing campaign may be aggregated and analyzed to obtain various measures of marketing effectiveness. By way of illustration and not by way of limitation, the data may be used to determine the effectiveness of various marketing strategies, the configuration of the marketing environment, the sensitivity of the store's clientele to particular offers, the time of day or the day of the week that an offer is most effective among other measures. These data may be evaluated along with the profile data of the user to determine the user's shopping patterns, the effectiveness of displays or other advertisements, and the effectiveness of coupons or other offers relating to a product or product family.

Tri-Layer Mobile Marketing Mapping

In economics, the sub-discipline of econometrics has been defined as broadly as the discipline concerned with the development of economic science in concert with mathematics and statistics. It has also been defined more narrowly as the application of mathematics and especially of statistical methods to economics. Theoretical econometrics studies the statistical properties of econometric procedures. Such properties include power of hypothesis tests and the efficiency of survey-sampling methods, of experimental designs and of estimators. Applied econometrics includes the application of econometric methods to assess economic theories and the development and use of econometric models, for use in economic history and in economic forecasting.

Many econometric methods represent applications of standard statistical models to study economic questions. Econometrics is especially concerned both with observational studies and with systems of equations. First, economic studies are most often observational, rather than controlled experiments. Therefore, the design of observational studies in econometrics is similar to the design of studies in other observational disciplines, such as astronomy, epidemiology, and political science; similarly, the statistical analysis of data from an observational study is guided by the study protocol, although exploratory analysis of data sets is useful for generating new hypotheses.

Path Modeling

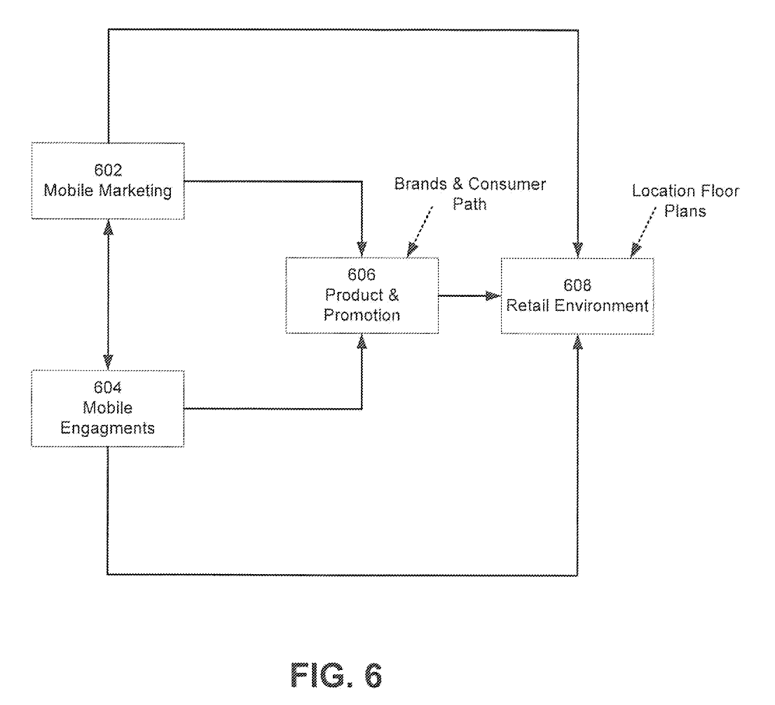

FIG. 6 is block diagram illustrating a correlation model according to an embodiment.

As illustrated in FIG. 6, two exogenous variables, mobile marketing (Block 602) and mobile marketing engagements (Block 604), are modeled as being correlated and as having both direct and indirect effects through two dependent variables, retail and real estate (Block 608) and product and brand placement (Block 606). The statistical models and the variables may also be affected by factors outside the model.

Using the same variables, alternative models are conceivable. For example, it may be hypothesized that product placement in a planogram has only an indirect effect on mobile marketing engagement, thus the arrow between the two would be deleted, and the likelihood or “fit” of these two models can be compared statistically and reports produced that leverage data collected throughout all three tiers of the data management structure.

In order to validly calculate the relationship between any two boxes in the diagram, Wright (1934) proposed a simple set of path tracing rules, for calculating the correlation between two variables. The correlation is equal to the sum of the contribution of all the pathways through which the two variables are connected. The strength of each of these contributing pathways is calculated as the product of the path-coefficients along that pathway. In an embodiment, the path equations and relationship correlations are performed by a processor so as to equate, display and deliver data to software such as a service (SaaS) platform accessed by administrators over authenticated network devices, and by consumers in mobile marketing engagements over any Internet connected device.

Using Statistical models, all relationships that exist between the layers may be calculated. The algorithms used to determine these relationships may be managed and revised. The algorithms may be used to create actionable and useful mobile marketing data including a visual database component that displays brands affiliated with a user profile managed over scalable computer network resources in an array or within a self contained network.

Statistical Modeling

In an embodiment, an anonymous statistical model is produced that is based on tracking opted-in consumer engagements within the overlapping three data layers that make up a data super structure that employs any number of networked and or Internet accessible resources. The anonymous consumer record is primarily focused on transforming data used to associate user profiles with products, brands and retail real estate into actionable and valuable mobile marketing analytics.

In another embodiment, visually integrated data may be delivered as a three-dimensional rendering. Text and graphical, animated, and image based data reports may also be produced. Consumer foot traffic through a facility may be mapped and anonymous brand affiliation profiles created from the tracking of consumer engagements within the mapped mobile marketing landscape.

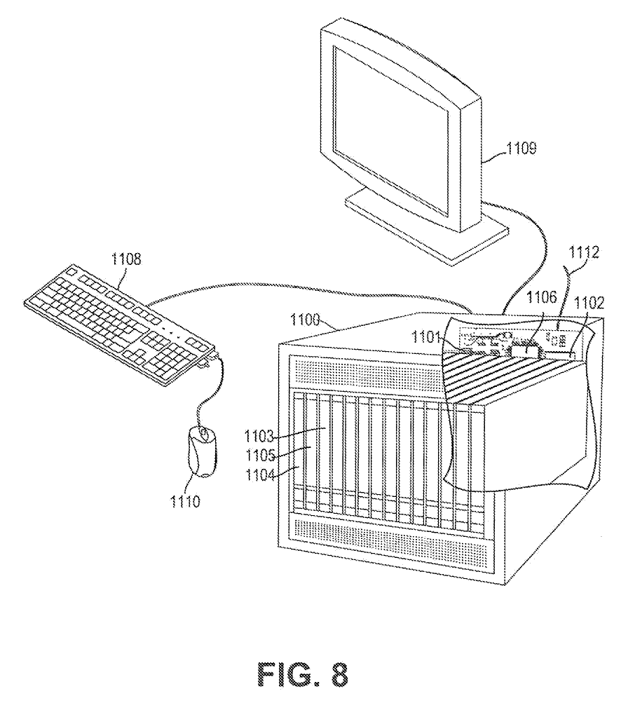

FIG. 8 is a block diagram of a computing device suitable for use with any of the embodiments.

The various embodiments may also be implemented on any of a variety of commercially available server devices, such as the server 1100 illustrated in FIG. 8. Such a server 1100 typically includes a processor 1101, for collection and analysis of the interaction data and other operations described herein, coupled to volatile memory 1102 and a large capacity nonvolatile memory, such as a disk drive 1103. The server 1100 may also include a floppy disc drive, compact disc (CD) or DVD disc drive 1104 coupled to the processor 1101. The server 1100 may also include network access ports 1106 coupled to the processor 1101 for establishing data connections with a network 1112, such as a local area network coupled to other broadcast system computers and servers. Servers 1100 may also include operator interfaces, such as a keyboard 1108, pointer device (e.g., a computer mouse 1110), and a display 1109.

The processor. 1101 may be any programmable microprocessor, microcomputer or multiple processor chip or chips that can be configured by software instructions (applications) to perform a variety of functions, including the functions of the anonymous profile management server 40 as described above.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware, used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in, conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module, which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A processor-based method of generating an anonymous profile, the method comprising:
receiving by a processor operating on a server a mobile device identifier, wherein the mobile device identifier is unique to a mobile computing device;
determining by the processor a location of the mobile computing device within a marketing environment;
associating by the processor the location of the mobile computing device with a location of a product within the marketing environment;
obtaining by the processor interaction data indicative of an engagement of the mobile computing device with the product; and
storing the interaction data in a profile associated with the mobile device identifier.

2. The processor-implemented method of claim 1, wherein the interaction data are selected from the group consisting of a speed at which the mobile computing device passed the location of the product, an amount of time the mobile computing device remained at the location of the product, a scan by the mobile computing device of a code associated with the product, a scan by the mobile computing device of an object associated with the product, a number of visits to the location of the product by the mobile computing device, a purchase of the product and a scan by the mobile computing device of an object representing another product related to the product.

3. The processor-implemented method of claim 1 further comprising determining by the processor a behavior of the user of the mobile computing device from the interaction data, wherein the behavior is selected from the group consisting of a pre-planned purchase, browsing, and a purchase inspired by marketing materials presented in the shopping environment.

4. The processor-implemented method of claim 1 further comprising determining by the processor a measure of interest in the product using the interaction data.

5. The processor-implemented method of claim 4 further comprising:
aggregating by the processor interaction data of the user of the mobile computing device and interaction data of other users of other mobile computing devices with the product;
determining by the processor an aggregated measure of interest in the product from the interaction data of the user and the interaction data of other users; and
measuring by the processor an effectiveness of product marketing materials related to the product from the aggregated measure of interest.

6. The processor-implemented method of claim 4 further comprising:
aggregating by the processor interaction data of the user of the mobile computing device and interaction data of other users of other mobile computing devices with the product;
determining by the processor an aggregated measure of interest in the product from the interaction data of the user and the interaction data of other users; and
measuring by the processor an effectiveness of a configuration of the marketing environment from the aggregated measure of interest.

7. The processor-implemented method of claim 4 further comprising:
aggregating by the processor interaction data of the user of the mobile computing device and interaction data of other users of other mobile computing devices with the product;
determining by the processor an aggregated measure of interest in the product from the interaction data of the user and the interaction data of other users; and
measuring by the processor an effectiveness of a marketing strategy implemented at a particular time of day or on a particular day of the week from the aggregated measure of interest.

8. The processor-implemented method of claim 5, wherein the marketing materials are selected from the group consisting of a display within the marketing environment, displays outside of the marketing environment, advertisements for the product provided in print media, advertisements for the product in video media, web-based advertisements for the product, a social networking campaign for the product, and coupons for the product.

9. The processor-implemented method of claim 1, wherein products in the marketing environment have known locations and determining by the processor a location of the mobile computing device within a marketing environment comprises determining the location of the mobile computing device from engagements between the mobile computing device and one or more products.

10. The processor-implemented method of claim 1, wherein determining by the processor the location of the mobile computing device comprises:
obtaining by the processor sensor data indicative of the proximity of the mobile computing device to a known location; and
determining by the processor the location of the mobile computing device using the sensor data.

11. The processor-implemented method of claim 1, wherein the mobile computing device is selected from the group consisting of a smartphone, a tablet and a personal data assistant.

12. A system for generating an anonymous profile, the system comprising:
a memory, wherein the memory comprises software executable instructions;
a profile management server, wherein the profile management server comprises a processor, a memory comprises software executable instructions, and wherein the first processor is configured with the software executable instructions from the memory to cause the profile management server to perform operations comprising:
receiving a mobile device identifier, wherein the mobile device identifier is unique to a mobile computing device;
determining by the processor a location of the mobile computing device within a marketing environment;
associating by the processor the location of the mobile computing device with a location of a product within the marketing environment;
obtaining by the processor interaction data indicative of an engagement of the mobile computing device with the product; and
storing the interaction data in a profile associated with the mobile device identifier.

13. The system of claim 1, wherein the interaction data are selected from the group consisting of a speed at which the mobile computing device passed the location of the product, an amount of time the mobile computing device remained at the location of the product, a scan by the mobile computing device of a code associated with the product, a scan by the mobile computing device of an object associated with the product, a number of visits to the location of the product by the mobile computing device, a purchase of the product and a scan by the mobile computing device of an object representing another product related to the product.

14. The system of claim 12, wherein the processor is configured with the software executable instructions to cause profile management server to perform operations further comprising determining a behavior of the user of the mobile computing device from the interaction data, wherein the behavior is selected from the group consisting of a pre-planned purchase, browsing, and a purchase inspired by marketing materials presented in the shopping environment.

15. The system of claim 12 wherein the processor is configured with the software executable instructions to cause profile management server to perform operations further comprising determining by the processor a measure of interest in the product using the interaction data.

16. The system of claim 15, wherein the processor is configured with the software executable instructions to cause profile management server to perform operations further comprising:
aggregating interaction data of the user of the mobile computing device and interaction data of other users of other mobile computing devices with the product;
determining an aggregated measure of interest in the product from the interaction data of the user and the interaction data of other users; and
measuring an effectiveness of product marketing materials related to the product from the aggregated measure of interest.

17. The system of claim 15, wherein the processor is configured with the software executable instructions to cause profile management server to perform operations further comprising:
aggregating interaction data of the user of the mobile computing device and interaction data of other users of other mobile computing devices with the product;
determining an aggregated measure of interest in the product from the interaction data of the user and the interaction data of other users; and
measuring an effectiveness of a configuration of the marketing environment from the aggregated measure of interest.

18. The system of claim 15, wherein the processor is configured with the software executable instructions to cause profile management server to perform operations further comprising:
aggregating interaction data of the user of the mobile computing device and interaction data of other users of other mobile computing devices with the product;
determining an aggregated measure of interest in the product from the interaction data of the user and the interaction data of other users; and
measuring an effectiveness of a marketing strategy implemented at a particular time of day or on a particular day of the week from the aggregated measure of interest.

19. The system of claim 5, wherein the marketing materials are selected from the consisting of a display within the marketing environment, displays outside of the marketing environment, advertisements for the product provided in print media, advertisements for the product in video media, web-based advertisements for the product, a social networking campaign for the product, and coupons for the product.

20. The system of claim 1, wherein products in the marketing environment have known locations and the operation determining a location of the mobile computing device within a marketing environment comprises determining the location of the mobile computing device from engagements between the mobile computing device and one or more products.

21. The system of claim 1, wherein the operation determining the location of the mobile computing device comprises:
obtaining sensor data indicative of the proximity of the mobile computing device to a known location; and
determining the location of the mobile computing device using the sensor data.

22. The system of claim 12, wherein the mobile computing device is selected from the group consisting of a smartphone, a tablet and a personal data assistant.
